(19) United States
(12) Patent Application Publication
(10) Pub. No.: US 2026/0125580 A1
(43) Pub. Date: May 7, 2026

(54) POLYSILOXANE RESIN AND MICA BLEND

(71) Applicant: Dow Silicones Corporation, Midland, MI (US)

(72) Inventors: Yanhu Wei, Midland, MI (US); Peng-Fei Fu, Midland, MI (US)

(21) Appl. No.: 19/474,941

(22) PCT Filed: Apr. 3, 2024
(86) PCT No.: PCT/US2024/022722

§ 371 Date: Oct. 13, 2025

Related U.S. Application Data
(60) Provisional application No. 63/461,654, filed on Apr. 25, 2023.

(51) Int. Cl. C09D 183/08; C08G 77/00; C08G 77/04; C08K 3/34; C09D 7/20; C09D 7/61

(52) U.S. Cl. CPC C09D 183/08; C08G 77/04; C09D 7/20; C09D 7/61; C08G 77/70; C08G 77/80; C08K 2003/343

(57) ABSTRACT

The present invention is composition comprising a mixture of a mica and a T^{R}-D^{RR} resin, where each R is independently phenyl or methyl, wherein the mole-to-mole ratio of D^{RR} units to T^{R} units is in the range of from 30:70 to 80:20; and wherein the weight-to-weight ratio of mica to the T^{R}-D^{RR} resin is in the range of 20:80 to 80:20. The composition of the present invention is useful as a coating for a substrate, wherein the coating exhibits good adhesion, and crack-resistance when subjected to high temperatures for several weeks.

### BACKGROUND OF THE INVENTION

The present invention relates to a silicone coating composition, more particularly a composition that is resistant to cracking and dielectric degradation at high temperatures, and a method for preparing the composition. High temperature protective coatings and insulating materials protect a variety of equipment and devices against extremely high temperatures. Heater elements for electric vehicles, exhaust systems for automotive engines, power plants, and top coatings for stoves, for example, all benefit from such protective coatings. In many applications, the coating layers must withstand temperatures exceeding 300° C. over several months without cracking or losing dielectric and insulating properties and must pass aggressive thermal shock tests over a broad temperature range.

High temperature resistance of silicones ostensibly makes them promising candidates as high temperature protective coatings and sealants; nevertheless, silicone rubbers are not resistant to cracking above 250° C. beyond 2 weeks. The combination of silicone and inorganic filler such as SiO₂, TiO₂, and Al₂O₃ provides a composition with long term high temperature resistance; however, coatings prepared from such compositions require aging at temperatures exceeding 500° C. to form ceramic-like coatings. At such extreme temperatures, the coatings are likely to crack and suffer thermal shock failure; moreover, electronic elements beneath the surface of the coating are vulnerable to damage. It would therefore be an advance in the field of high temperature protective coatings to develop a composition that provides a coating that is resistant to cracking, delamination, and thermal shock failure, while maintaining acceptable dielectric properties at temperatures exceeding 300° C. for an extended period.

### SUMMARY OF THE INVENTION

The present invention addresses a need in the art by providing a composition comprising a mixture of a mica and a T^{R}-D^{RR} resin, where each R is independently phenyl or methyl, wherein the mole-to-mole ratio of D^{RR} units to T^{R} units is in the range of from 30:70 to 80:20; and wherein the weight-to-weight ratio of mica to the T^{R}-D^{RR} resin is in the range of 20:80 to 80:20. The composition of the present invention is useful as a coating for a substrate, wherein the coating exhibits good adhesion, and crack-resistance when subjected to high temperatures for several weeks.

### DETAILED DESCRIPTION OF THE INVENTION

The present invention is a composition comprising a mixture of a mica and a T^{R}-D^{RR} resin, where each R is independently phenyl or methyl, wherein the mole-to-mole ratio of D^{RR} units to T^{R} units is in the range of from 30:70 to 80:20; and wherein the weight-to-weight ratio of mica to the T^{R}-D^{RR} resin is in the range of 20:80 to 80:20.

The term “T^{R}-D^{RR} resin” refers to a kinetically stable three-dimensional polymer having repeat units of R—SiO_{3/2}, R—SiO_{2/2}(OZ), and optionally R—SiO_{1/2}(OZ)₂ (collectively T^{R}); and R₂SiO_{2/2} (D_{RR}).

A unit of R—SiO_{3/2} is represented by the following structure:

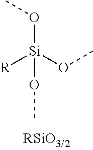

where each R is methyl or phenyl.

R—SiO_{2/2}(OZ) is represented by the following structure:

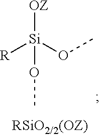

where Z is H, C₁-C₄-alkyl, or C(O)CH₃; and a unit of RSiO_{1/2}(OZ)₂ is represented by the following structure:

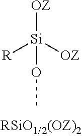

Each Z in the T^{R} portion of the resin is preferably methyl or H.

A unit of R₂SiO_{2/2} is represented by the following structure:

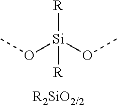

where each R is independently methyl or phenyl.

Micas are hydrated aluminum silicate minerals including muscovite, biotite, fuchsite, phlogopite, margarite, glauconite, and lepidolite micas, of which muscovite mica and phlogopite mica are predominant.

The mole-to-mole ratio or D^{RR} units to T^{R} units is in the range of from 30:70 or from 35:70, to 80:20, or to 70:30 or to 65:35. The w/w ratio of the mica to the T^{R}-D^{RR} resin is in the range of from 80:20 or from 70:30 or from 65:35 or from 60:40, to 20:80 or to 30:70 or to 35:65 to 40:60.

The composition advantageously contains an aprotic solvent such as propylene glycol methyl ether acetate, ethyl acetate, propyl acetate, butyl acetate, toluene, xylene, and propyl propionate. The amount of aprotic solvent is sufficient to achieve a Brookfield viscosity at 25° C. in the range of from 20 cP or from 50 cP or from 100 cP, to 20,000 cP or to 10,000 cP or to 5,000 cP, or to 1200 cP; alternatively, the concentration of aprotic solvent is in the range of from 5 or from 10 or from 20 weight percent, to 90 or to 75 or to 60 weight percent, based on the weight of the composition.

In another aspect of the present invention, the composition comprises a blend of a T^{R}-D^{RR} resin; a mica; an aprotic solvent; a compound of the formula R²Si(OR₃)₃, where R₂ is C₁-C₁₂-alkyl or aryl, and R³ is C₁-C₄-alkyl, such as methyltrimethoxysilane, phenyltrimethoxysilane, methyltriethoxysilane, and ethyltrimethoxysilane; and a moisture cure catalyst, for example, a tin-based catalyst such as tin octanoate or tin butanoate, or a titanium-based catalyst such as tetraisopropyl titanate, tetra-n-butyl titanate, and tetra-t-butoxy titanate.

In yet another aspect, the present invention is a process for preparing a cured coating on a substrate. The present invention is also an article comprising a substrate coated with the cured composition. The thickness of the coating is generally in the range of from 20 μm to 300 μm.

The composition of the present invention provides a coating for a substrate such as a metal, a metal oxide, a ceramic, or a plastic substrate, that is tack-free in less than 30 minutes at ambient temperature, and thermally stable to cracking for hundreds or even thousands of hours.

### Examples

### Intermediate Comparative Example 1—Preparation D_{0.15}D^{PHPh}_{0.05}T_{0.10}T^{Ph}_{0.70} Resin

Me₂SiCl₂ (0.15 mole), Ph₂SiCl₂ (0.05 mol), MeSiCl₃ (0.10 mole), and PhSiCl₃ (0.70 mole) were co-hydrolyzed in toluene by the addition of water (2.5 mole) at ambient temperature. The hydrolyte was then heated at 60° C. for 4 h. The resin solution was then washed several times with water to remove acid. The solution was heated in vacuo to form a solid resin, which was crushed into flakes by chilled rolls.

### Intermediate Comparative Example 2—Preparation of D^{Ph}_{0.05}D^{PHPh}_{0.15}T_{0.45}T^{Ph}_{0.40} Resin

The method used to prepare Intermediate Comparative Example 1 was repeated except that the starting materials were PhMeSiCl₂ (0.05 mole), Ph₂SiCl₂ (0.15 mol), MeSiCl₃ (0.45 mole), and PhSiCl₃ (0.40 mole).

### Intermediate Example 1—Preparation of D^{Ph}_{0.5}D^{PhPh}_{0.1}T_{0.25}T^{Ph}_{0.15} Resin

The method used to prepare Intermediate Comparative Example 1 was repeated except that the starting materials were PhMeSiCl₂ (0.5 mole), Ph₂SiCl₂ (0.1 mol), MeSiCl₃ (0.25 mole), and PhSiCl₃ (0.15 mole), and the reaction was carried for 5 h, after which time the solution was concentrated to 50 wt % of the targeted resin.

### Intermediate Example 2—Preparation of D_{0.19}D^{PhPh}_{0.19}T_{0.25}T^{Ph}_{0.37}

The method used to prepare Intermediate Example 1 was repeated except that the starting materials were Me₂SiCl₂ (0.19 mole), Ph₂SiCl₂ (0.19 mol), MeSiCl₃ (0.25 mole), and PhSiCl₃ (0.37 mole).

### Comparative Example 1—Preparation of Blend of Mica and D_{0.15}D^{PhPh}_{0.05}T_{0.10}T^{Ph}_{0.70} Resin

Intermediate Comparative Example 1 resin (D_{0.15}D^{PhPh}_{0.05}T_{0.10}T^{Ph}_{0.70}, 100 pbw) was dissolved in butyl acetate (50 pbw) in a flask. MRX muscovite mica (100 pbw) was added to the flask and the contents were mixed using a mechanical stirrer for 2 h.

### Comparative Example 2—Preparation of Blend of Mica and D^{Ph}_{0.05}D^{PhPh}_{0.15}T_{0.45}T^{Ph}_{0.40} Resin

The method used to prepare Comparative Example 1 was repeated except that Intermediate Comparative Example 2 resin (D^{Ph}_{0.05}D^{PhPh}_{0.15}T_{0.45}T^{Ph}_{0.40}, 100 pbw) was combined with the MRX muscovite mica (100 pbw).

### Example 1—Preparation of Blend of Mica and D^{Ph}_{0.5}D^{Phph}_{0.1}T_{0.25}T^{Ph}_{0.15} Resin

Intermediate Example 1 resin solution (D^{Ph}_{0.5}D^{PhPh}_{0.1}T_{0.25}T^{Ph}_{0.15}, 100 pbw solid resin, 200 pbw total) was mixed with MRX muscovite mica (100 pbw) in a flask for 2 h.

### Example 2—Preparation of Blend of Mica and D_{0.19}D^{PhPh}_{0.19}T_{0.25}T^{Ph}_{0.37} Resin

The method used to prepare Example 2 was repeated except that Intermediate Example 2 resin (D_{0.19}D^{PhPh}_{0.19} T_{0.25}T^{Ph}_{0.37}, 100 pbw solid resin, 200 pbw total) was mixed with MRX muscovite mica (100 pbw) in a flask for 2 h.

### Preparation of Coatings

Aluminum panels (Type A from Gardco, 3″×6″) were washed with toluene and acetone and dried by air flow before use. A portion of the prepared formulation (2 g) was coated on the panel to form a film with a thickness in the range of from 50 μm to 100 μm films using a 4-mil drawdown bar. The coated films were dried at 70° C. for 30 min under air flow to remove solvents. The dry films were cured at room temperature or 200° C. for 10 min to 60 min, followed by thermally aging at 300° C.

### Measurement of Cracking Time

The cured coatings were aged in an oven at 300° C. In the first 14 days (d), sample cracking was checked every other day for each sample, and then checked once per week. The cracking time was recorded when some cracks were observed to form in the coatings.

### Thermal Cycle Test

Each formulation was coated as 100-μm thick film, followed by curing at room temperature or 150° C., then aged at 300° C. for 10 d. Then, the samples were subjected to 100 cycles of temperature cycling between −50° C. and 150° C. at a temperature ramping rate 20 C°/min, 10 min per cycle, using a Tenney Thermal Chamber. A coated sample was deemed to pass the thermal cycle test if no cracks or delamination were observed after completion of the test.

Table 1 illustrates the results of cracking time for samples with and without mica. ICE1 and ICD2 refer to intermediate comparative examples 1 and 2, respectively; IE1 and IE2 refer to intermediate examples 1 and 2, respectively. TCT refers to thermal cycle test; mica refers to MRX muscovite mica.

TABLE 1
Crack time and Thermal Cycle Test Results for Coatings

| Example | Resin | D mole % | mica wt % | Cracked time | | TCT |
|---|---|---|---|---|---|---|
| CE 1 | ICE 1 | 20% | 50% | 5 | d | fail |
| CE 2 | ICE 2 | 20% | 50% | 5 | d | fail |
| CE 3 | IE 1 | 38% | 0 | 5 | d | fail |
| CE 4 | IE 2 | 60% | 0 | 15 | d | fail |
| Ex 1 | IE 1 | 38% | 50% | >63 | d | pass |
| Ex 2 | IE 2 | 60% | 50% | >80 | d | pass |

The results show a dramatic difference in crack time and thermal cycle testing results for blends containing the T^{R}D^{RR} resin and mica versus mica free samples. Moreover, no additional polyorganosiloxane is required to achieve resistance to crack, provided the concentration of D units in the resin is sufficiently high.

Of the fillers tested-silica, calcium carbonate, aluminum silicate, calcium silicate, alumina, ferric oxide, and mica-mica was found to be the only class of fillers to exhibit crack times beyond 120 h.

1. A composition comprising a mixture of a mica and a T^{R}-D^{RR} resin, where each R is independently phenyl or methyl, wherein the mole-to-mole ratio of D^{RR} units to T^{R} units is in the range of from 30:70 to 80:20; and wherein the weight-to-weight ratio of mica to the T^{R}-D^{RR} resin is in the range of 20:80 to 80:20.

2. The composition of claim 1 which further comprises a sufficient concentration of an aprotic solvent to achieve a composition Brookfield viscosity at 25° C. in the range of from 20 cP to 10,000 cP.

3. The composition of claim 2 wherein the weight-to-weight ratio of the mica to the T^{R}-D^{RR} resin is in the range of from 30:70 to 70:30; mole-to-mole ratio of D^{RR} units to T^{R} units is in the range of from 35:65 to 70:30; and the concentration of the aprotic solvent is sufficient to achieve a Brookfield viscosity at 25° C. in the range of from 50 cP to 5,000 cP, wherein the aprotic solvent is propylene glycol methyl ether acetate, ethyl acetate, propyl acetate, butyl acetate, toluene, xylene, or propyl propionate.

4. The composition of claim 3 wherein the weight-to-weight ratio of the mica to the T^{R}-D^{RR} resin is in the range of from 35:65 to 70:30; the mole-to-mole ratio of D^{RR} units to T^{R} units is in the range of from 35:65 to 65:35; and the concentration of the aprotic solvent is sufficient to achieve a Brookfield viscosity at 25° C. in the range of from 100 cP to 1,200 cP; wherein the mica is muscovite, biotite, fuchsite, phlogopite, margarite, glauconite, or lepidolite.

5. The composition of claim 4 wherein the mica is muscovite mica.

6. The composition of claim 1 which further comprises a compound of the formula R²Si(OR³)₃, where R² is C₁-C₁₂-alkyl or aryl; and R³ is C₁-C₄-alkyl; and a moisture cure catalyst.

7. The composition of claim 6 wherein the compound of the formula R²Si(OR³)₃ is methyltrimethoxysilane or phenyltrimethoxysilane; and the moisture cure catalyst is a tin-based or a titanium-based catalyst.

8. A process comprising the steps of coating a substrate with the composition of claim 7 then curing the coating.

9. An article comprising a substrate and a coating having a thickness in the range of from 20 μm to 300 μm disposed thereupon, where the coating comprises a cured composition of claim 8.
